(19) United States
(12) Patent Application Publication
(10) Pub. No.: US 2024/0070227 A1
(43) Pub. Date: Feb. 29, 2024

(54) SYSTEMS AND METHODS FOR GENERATING MODELS TO IDENTIFY FUTURE STATES

(71) Applicant: SonderMind Inc., Denver, CO (US)

(72) Inventor: Jonathan KNIGHTS, Lawrenceville, NJ (US)

(21) Appl. No.: 18/238,251

(22) Filed: Aug. 25, 2023

Related U.S. Application Data
(60) Provisional application No. 63/400,770, filed on Aug. 25, 2022.

(51) Int. Cl. G06F 17/18

(52) U.S. Cl. CPC G06F 17/18

(57) ABSTRACT

A method includes receiving, at a processor, past state data and past activity data and generating (1) a covariance matrix based on a state model, an activity dissipation model, and an activity magnitude model, associated with a group including the user, (2) at least one activity impact dissipation parameter associated with the user, and (3) at least one activity magnitude parameter associated with the user. The method includes generating at least one state impact value based on the at least one activity impact dissipation parameter and the at least one activity magnitude parameter. The method includes generating a non-linear regression model associated with a future state based on the past state data, the past activity data, and the at least one state impact value, calculating future state data based on the non-linear regression model, and transmitting at least one signal to cause display of the future state data.

### CROSS-REFERENCE TO RELATED APPLICATION

This application claims priority to and the benefit of U.S. Provisional Patent Application No. 63/400,770, filed Aug. 25, 2022 and titled “Modeling Mental Healthcare User Data to Generate Recommendations for Optimized Outcomes,” which is incorporated herein by reference in its entirety.

### FIELD

One or more embodiments described herein relate to systems and computerized methods and models for calculating future states and generating future processes.

### BACKGROUND

The impact of an activity on a state can be determined by an activity type and an activity interval. As such, it can be desirable to have systems configured to identify potential future activities based on a calculated impact on a state.

### SUMMARY

According to an embodiment, a method includes receiving, at a processor, past state data associated with a user and past activity data associated with the user. The method also includes generating, via the processor, (1) a covariance matrix based on a state model, an activity dissipation model, and an activity magnitude model, associated with a group including the user, (2) at least one activity impact dissipation parameter associated with the user, and (3) at least one activity magnitude parameter associated with the user. The method also includes generating at least one state impact value based on the at least one activity impact dissipation parameter, and the at least one activity magnitude parameter. The method also includes generating a non-linear regression model (e.g., a Hill model) associated with a future state based on the past state data, the past activity data, and the at least one state impact value. The method also includes calculating, via the processor, future state data based on the non-linear regression model. The method also includes transmitting, via the processor, at least one signal configured to cause display of the future state data to the user.

In some embodiments, a non-transitory processor-readable medium stores code representing instructions to be executed by one or more processors. The instructions include code to cause the one or more processors to receive (1) at least one intensity value associated with a physical state and (2) at least one time value associated with at least one program type. The code also causes the one or more processors to calculate at least one type-specific state reduction value associated with the physical state based on at least one response model for the at least one program type and the at least one time value. The code also causes the one or more processors to calculate a total state reduction value based on the at least one type-specific state reduction value. The code also causes the one or more processors to calculate at least one future intensity value based on the total state reduction value. The code also causes the one or more processors to cause display of the at least one future intensity value.

### BRIEF DESCRIPTION OF THE DRAWINGS

FIG. 1 is a schematic diagram of a system, according to an embodiment.

FIG. 2 is a schematic diagram of a compute device included in a system, according to an embodiment.

FIG. 3 is a graphical representation of reported depression symptoms data for example users in view of a number and frequency of interventions, according to an embodiment.

FIG. 4 is a schematic diagram of an improved framework model that is included in a system, according to an embodiment.

FIG. 5A-5I are charts showing modeled predictions of treatment outcomes for example users, according to an embodiment.

FIG. 6 is a schematic diagram of components that are included in a system, according to an embodiment.

FIG. 7 is a flowchart showing a method of using a system to calculate a future state, according to an embodiment.

FIG. 8 is a flowchart showing a method of using a system to calculate a future state, according to an embodiment.

FIG. 9 is a flowchart showing a method of using a system to generate potential future healthcare services information to improve outcomes, according to an embodiment.

### DETAILED DESCRIPTION

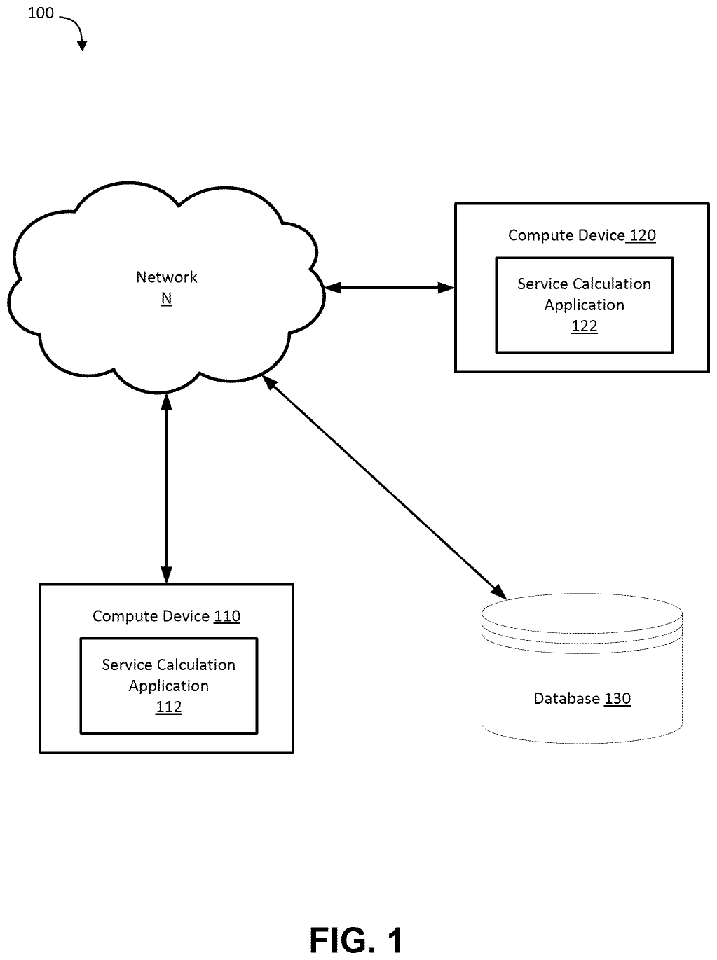

FIG. 1 is a schematic diagram of a system 100 for calculating and/or predicting effects of activities and/or services on a state, according to one embodiment. In some implementations, the state can be associated with a mental health condition, the activities and/or services can be associated with mental health treatment, and the system 100 can be configured to provide customized potential future mental healthcare services to improve outcomes, as described herein. The system 100 includes compute devices 110 and 120, storage system 130, and network N. The system 100 can include alternative configurations, and various steps and/or functions of the processes described below can be shared among the various devices of the system 100 or can be assigned to specific devices (e.g., the compute devices 110 and 120, the storage system 130, and/or the like).

The compute devices 110 and/or 120 can include any suitable hardware-based computing devices and/or multimedia devices, such as, for example, a server, a desktop compute device, a smartphone, a tablet, a wearable device, a laptop and/or the like. In some implementations, the compute devices 110 and/or 120 can be implemented at an edge node or other remote computing facility. In some implementations, the compute devices 110 and/or 120 can be a data center or other control facility configured to run a distributed computing system, and can communicate with other compute devices. As described herein, the compute devices 110 and/or 120 can be used for implementing the models, running an application, generating user recommendations, providing feedback to a server, and otherwise implementing steps in a method (e.g., a mental healthcare recommendations method, as described herein).

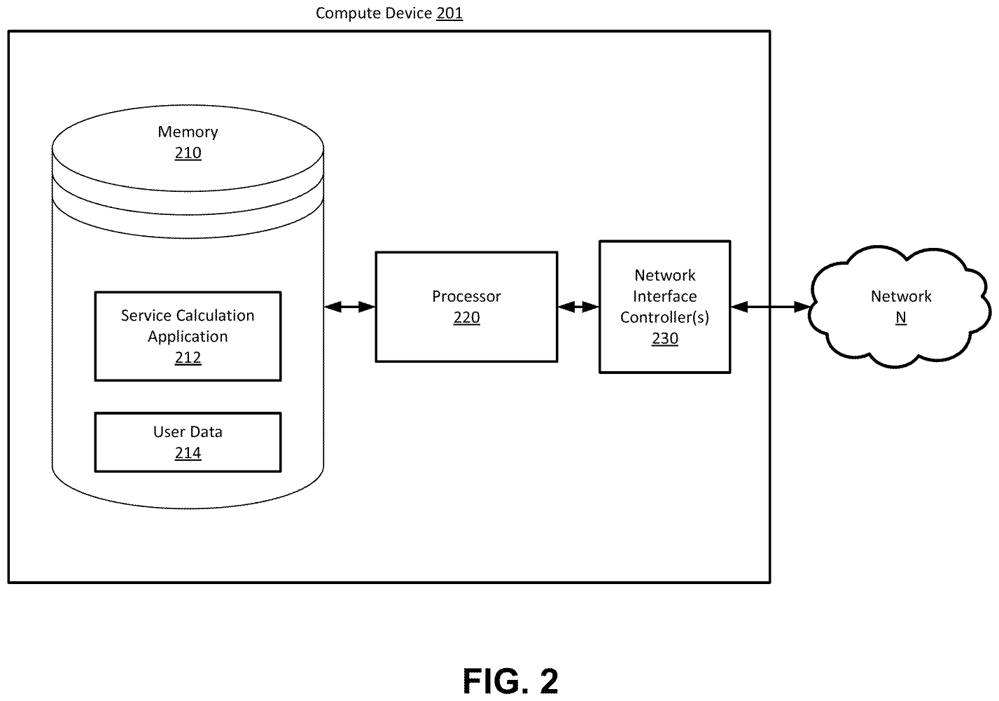

In some implementations, the system 100 can include a distributed computing system implemented by three or more compute devices (e.g., one or more compute devices in addition to the compute devices 110 and 120 shown in FIG. 1). In some examples, each of a plurality of compute devices can include one or more of processors, respectively, and one or more memories. The processors can function similar to the processor 220 in FIG. 2, as described herein. The memories can function similar to memory 210 in FIG. 2, as described below.

The compute devices 110 and/or 120 can be configured to execute (e.g., via a processor) the service calculation applications 112 and 122 respectively. The service calculation applications 112 and 122 can be separate instances of the same application. The service calculation applications 112 and/or 122 can include instructions which, when executed by a processor (e.g., the processor 220 of FIG. 2, as described herein), cause the compute devices 110 and/or 120 to perform various steps and/or functions (e.g., implementing an improved framework model and other algorithms), as described herein. The service calculation applications 112 and/or 122 can further include instructions for generating a user interface (e.g., graphical user interface (GUI)) that is configured to collect information from a user and/or display predicted/generated data and/or recommendations. In some instances, the compute devices 110 and 120 can be edge nodes that are communicatively coupled via a network, as described herein.

In some instances, the service calculation applications 112 and/or 122 can include a computational framework (e.g., an optimization framework) that leverages historical and incoming data to capture population-level and individual-level responses to services (e.g., mental health services). In some examples, the computational framework may include an adaptive, parametric, modeling and simulation framework. Evidence-based expectations around whether or not users are receiving the right amount and the right type of care may be established and calibrated based on said individual-level responses (e.g., values from a given user's symptom report data, and other data representative of mental health disposition), and population-level responses (e.g., an average, weighted average, other distributional characteristics and aggregate measure of values from a plurality of users' symptom report data). Users may include mental health patients, members of a mental healthcare platform or community, or some other person seeking mental healthcare services. In some examples, population-level response data may be general to the population of users or may be broken down to represent a subset of the population of users. For example, population-level response data may be organized to represent one or more demographics (e.g., age, gender, geography, education, ethnicity). In another example, population-level response data may be organized to represent one or more mental conditions or disorders (e.g., disorders identified in the Diagnostic and Statistical Manual of Mental Disorders (DSM), such as depression, anxiety, addiction, impulse control, affective disorders, psychotic disorders, eating disorders, as well as other mental health disorders). The computational framework may be updated routinely, continuously, periodically, or ad hoc, as new data (e.g., symptom report data and other observational data) becomes available. The computational framework may be used to proactively plan an improved schedule of mental health services (e.g., to reduce one or more symptoms, maintain a low level of one or more symptoms, and to achieve other mental health goals). In some instances, a schedule of mental health services can include a set of interventions.

In some examples, the computational framework may be built on a general, hierarchical, dynamic systems modeling approach (e.g., as often applied in capturing biological responses to active pharmacologic interventions), for example a hierarchical non-linear mixed effects model. In some examples, by approaching mental health services as analogous to a pharmacologic intervention (e.g., modifying underlying symptom dynamics), the computational framework may be able to capture a symptom severity response trajectory of a user. In some examples, the computational framework may use an adapted indirect response (IDR) model, conceptualizing an intervention (e.g., session) as a form of therapeutic intervention. Further, the model may incorporate a flexible multivariate covariance structure so that the computational framework can leverage population information to make predictions on likely utility of unobserved intervention types, for example, for users who have not engaged with a certain type(s) of available services. For example, if a user has interacted with therapy and psychiatry services, and not other services, the computational framework can, for example, be able to provide an evidence-based assessment at how useful the addition of the other services (e.g., care partner interventions, as described herein) would be for that user's symptom resolution. The figures that follow highlight observed member timeline data with depressive symptom severity as an example. Model fits and subsequent simulated data projecting expected symptom trajectories given a new intervention cadence is shown.

In alternative embodiments, one or more models and/or algorithms (e.g., Stochastic Approximation Expectation-Maximization (SAEM), First-Order Conditional Expectation with Interaction (FOCE-I), and the like) can be used to leverage patient self-reported symptom dynamics data to improve the frequency and types of mental health services. In some instances, symptom dynamics data can refer to data representing a magnitude of symptoms at a given moment and may include repeated observation of severity levels over time (e.g., longitudinal self-reported data). Symptom dynamics data may be represented as a symptom and/or disease severity measure (i.e., value). In some examples, self-reported symptom dynamics data may be generated based on responses to a symptom survey. For example, estimation algorithms may be used to generate a probable set of parameter values given data from a symptom survey.

In some examples, a symptom survey may request responses regarding symptom severity (e.g., low-medium-high scale, number scale, moderate-to-severe scale) for a condition or disorder. An example survey may generate values of severity of symptoms across a domain (e.g., a level 1 assessment). Another example survey may generate more granular values for severity of more detailed symptoms (e.g., a level 2 assessment), from which an aggregate severity score for a condition or disorder may be derived. Such surveys may be administered to patients periodically (e.g., a survey cycle of 30 days, 60 days, weekly, monthly), ad hoc (e.g., after each clinical intervention, when user chooses), or per a different schedule. Data elements from surveys and other data sources that may be useful to generating self-reported symptom dynamics data may include timing of interventions, timing of survey submission, type of interventions (e.g., booked and/or attended), levels of symptom severity and timing associated with said symptom severity (e.g., actual date and time, relative time to an intervention and intervention type, relative time to last report of symptoms), among others. In some examples, additional user data (e.g., individually or in aggregate) beyond self-reported symptom dynamics data may be used as model inputs for more granular modeling of symptom dynamics (e.g., laboratory test results, mood reports, audio/text samples (e.g., journal submissions), clinician interactions, clinician reports, sensor data (e.g., using SensorKit® or other sets of sensors associated with, for example, wearables) and/or other passive data).

In some examples, additional data inputs may be used to modify an objective function to improve for goals beyond symptom reduction (e.g., severity, frequency). For example, the framework described herein may be used to calculate a potential future (e.g., recommended) treatment process and/or schedule improved for one or a combination of time, cost, or other factors, in addition to symptom reduction.

Storage system 130 may include a plurality of repositories and/or other forms of data storage, and storage system 130 also may be in communication with compute devices 110 and/or 120. In another embodiment, storage system 130, which may include a plurality of repositories, may be housed in one or more of compute devices 110 and/or 120. In some examples, storage system 130 may store neural networks, user data (e.g., symptoms data, interventions/dose data, aggregated data), models, instructions, programs, and other various types of information as described herein. This information may be retrieved or otherwise accessed by one or more compute devices, such as compute devices 110 and/or 120, to perform at least some of the features (e.g., in relation to service calculation applications 112 and/or 122) described herein. Storage system 130 may include any type of computer storage, such as a hard drive, memory card, ROM, RAM, DVD, CD-ROM, write-capable, and read-only memories. In addition, storage system 130 may include a distributed storage system where data is stored on a plurality of different storage devices, which may be physically located at the same or different geographic locations (e.g., in a distributed computing system).

Storage system 130 can be networked, via the network N, to the compute devices 110 and/or 120 directly using wired connections and/or wireless connections. In some examples, the system 100 described herein can be implemented in an online mental healthcare service platform that is associated with the network N. The network N can include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other compute devices, such as modems and wireless interfaces.

FIG. 2 is a schematic diagram of a compute device 201 of a system, according to an embodiment. The compute device 201 can be structurally and/or functionally similar to, for example, the compute devices 110 and/or 120 of the system 100 shown in FIG. 1. Compute device 201 can be a hardware-based computing device, a multimedia device, or a cloud-based device such as, for example, a computer device, a server, a desktop compute device, a laptop, a smartphone, a tablet, a wearable device, a remote computing infrastructure, and/or the like. Compute device 201 includes a memory 210, a processor 220, and one or more network interface controllers 230.

The processor 220 can be, for example, a hardware based integrated circuit (IC), or any other suitable processing device configured to run and/or execute a set of instructions or code (e.g., stored in memory 210). For example, the processor 220 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a remote cluster of one or more processors associated with a cloud-based computing infrastructure and/or the like. The processor 220 is operatively coupled to the memory 210 (described herein). In some embodiments, for example, the processor 220 can be coupled to the memory 210 through a system bus (for example, address bus, data bus and/or control bus).

The memory 210 can be, for example, a random-access memory (RAM), a memory buffer, a hard drive, a read-only memory (ROM), an erasable programmable read-only memory (EPROM), and/or the like. The memory 210 can store, for example, one or more software modules and/or code that can include instructions to cause the processor 220 to perform one or more processes, functions, and/or the like. In some implementations, the memory 210 can be a portable memory (e.g., a flash drive, a portable hard disk, and/or the like) that can be operatively coupled to the processor 220. In some instances, the memory can be remotely operatively coupled with the compute device 201, for example, via the one or more network interface controllers 240. For example, a remote database server can be operatively coupled to the compute device 201.

The memory 210 can store various algorithms and/or data, including neural networks (e.g., convolutional neural networks) and data regarding symptoms, interventions, mental health disorders, demographics, among other types of data. Memory 210 can further include any non-transitory computer-readable storage medium for storing data and/or software that is executable by processor 220, and/or any other medium which may be used to store information that may be accessed by processor 220 to control the operation of the compute device 201. For example, the memory 210 can store data associated with the service calculation application 212, and user data 214. The service calculation application 212 can be functionally and/or structurally similar to the service calculation application 112. As described herein, the user data 214 can be associated with, for example, a plurality of users' self-reported state and/or symptoms relative to the programs (e.g., care interventions) in which the respective users have engaged and a time frame (e.g., hours, days, weeks, months, etc.). In some instances, the user data 214 can be associated with a plurality of users that includes the specific user. Said differently, the user data 214 can include a set of individual observations. In some instances, the user data 214 can include data that is unobserved as to a specific user. In some instances, the service calculation application 112 can be configured to update the user data 216 based on new data from a specific user(s). In some instances, the update(s) to the user data 216 can result in iterative updates to a covariance matrix, as described herein.

The one or more network interface controllers 230 can be configured to connect to the network N using any of the wired and wireless short range communication protocols described above, as well as a cellular data network, a satellite network, free space optical network and/or the Internet.

In some instances, the compute device 201 can further include a display, an input device, and/or an output module. The display can be any display device by which the compute device 201 can output and/or display data. The input device can include a mouse, keyboard, touch screen, voice interface, and/or any other hand-held controller or device or interface by means of which a user may interact with the compute device 201. The output module can include a bus, port, and/or other interfaces by which the compute device 201 may connect to and/or output data to other devices and/or peripherals.

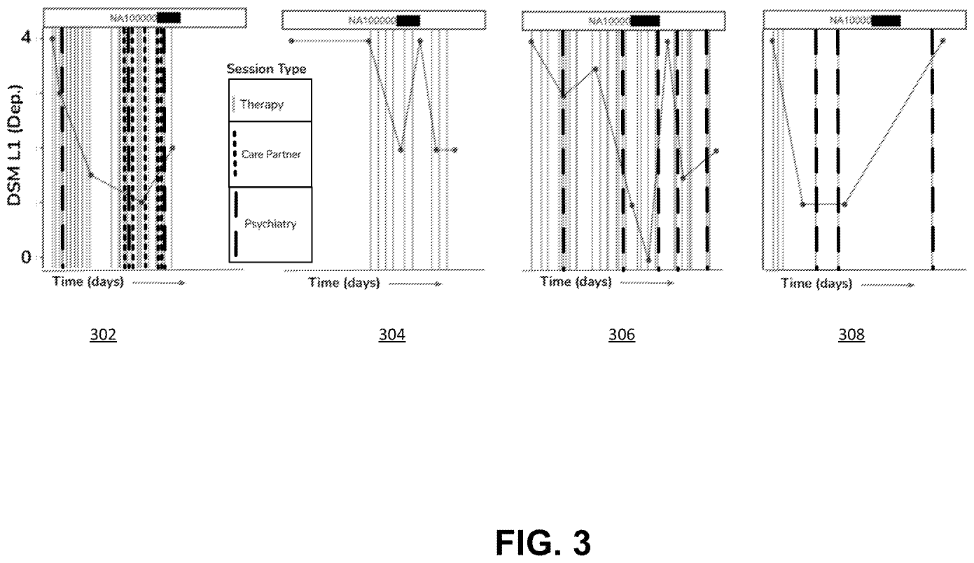

FIG. 3 shows data representations 302-308 of reported depression symptoms data for example users in view of a number and frequency of interventions, in accordance with one or more embodiments. In some instances, each user from the example users can be associated with a different data representation from the data representations 402-408. In FIG. 3, the care intervention types may include a care partner intervention (e.g., case manager, coach, etc.), a therapy intervention with a therapist team member (e.g., licensed therapist, licensed clinical social worker (LCSW), licensed clinical psychologist, and/or other social worker), and a psychiatry intervention with a psychiatric team member (e.g., licensed psychiatrist, psychiatric nurse (e.g., Advanced Practice Registered Nurse (APRN), clinical specialist (CNS), and nurse practitioner (NP)), LCSW, and/or other social worker) to discuss psychiatric-related medical topics and medication management. The dots can indicate a value representing the user's self-reported reported symptoms relative to the programs (e.g., healthcare interventions and/or healthcare sessions) in which the user has engaged and a time frame (e.g., hours, days, weeks, months, etc.). This data may include data for a plurality of users (e.g., a population), as described herein.

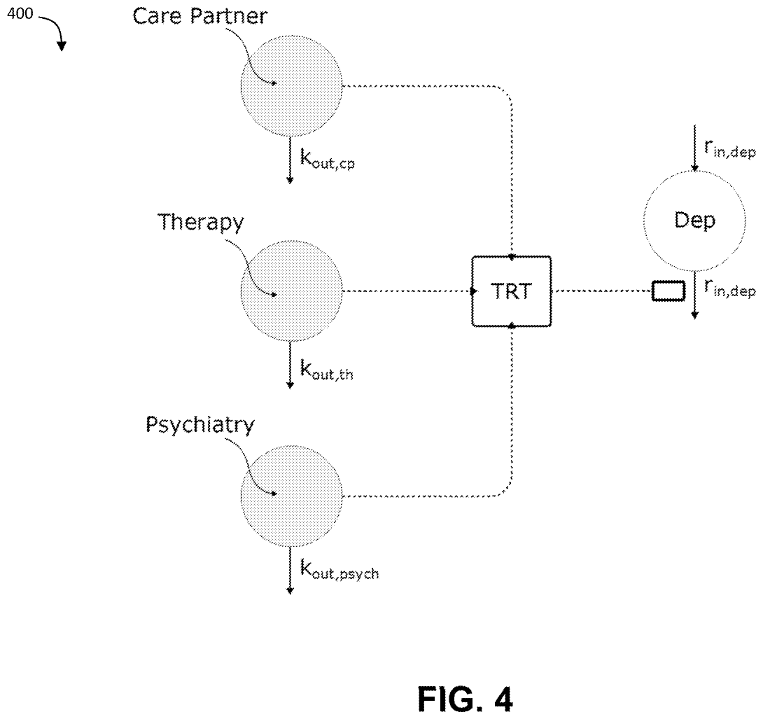

FIG. 4 is a schematic diagram of a framework model 400 for capturing the effect of service types on mental health symptoms, in accordance with one or more embodiments. The framework model 400 shows a model for an example set of symptoms associated with depression disorders. More specifically, the model represents the impact of sessions/interventions on symptoms by increasing a rate of elimination of a depressive symptom(s) in response to the session/intervention. In some instances, the depressive symptom(s) can have a natural turnover and elimination process. The session/intervention can be associated with one, or a combination, of care partner, therapy, and psychiatry interventions. In some examples, the model can also represent other sets of symptoms (e.g., associated with other disorders). Within the framework model 400, completing a program (e.g., intervention) of a specific type generates a type-specific state reduction value (e.g., a “dose”) associated with the program (e.g., the intervention), which has the ability to impact depressive symptoms, but also dissipates at a certain rate over time (k_{out,i}). Said differently, a dose of an intervention can impact a physical state (e.g., an emotional state) as characterized by the type-specific (as to the type of intervention) state reduction value. A total state reduction value can include a sum of type specific state reduction values for different programs and/or interventions. In some instances, a latent treatment mass (e.g., a TRT value) can represent a sum of latent treatment mass in each of the intervention compartments (e.g., programs). In some instances, the rate of depressive symptom elimination can be modeled as a Hill model/equation with a maximum capacity term (Sₘₐₓ) and a sensitivity term (SC₅₀). For example, the framework model 400 can parameterize (e.g., generate and/or estimate parameters for) a Hill equation using non-linear regression. Based on the parameterization, the resulting non-linear regression model can represent a dose response (e.g., a state response to an activity/service). In some examples, as shown, the TRT value may represent a total impact (e.g., sum, average, weighted average, other representation) of a set of symptoms and intervention data (e.g., current and historical) across available services.

In some examples, the TRT value may represent a total impact of a set of symptoms and intervention data for a single or subset of services. The set of historical symptoms and interventions may include at least some interventions for a user, a group of users, or a population. As there is no evidence to suggest what the magnitude of a single intervention type should be, the Vᵢ parameters serve to scale the value of each intervention type to the best supported value for the data. As shown, the TRT box may represent the aggregate treatment amount (i.e., “aggregated treatment dose”) at a given time across the types of services. In some instances, the TRT value can be used to determine a magnifier for the removal (e.g., rate of decrease) of depressive symptoms from the system based on at least one system capacity term. In some examples, the symptoms and intervention data may include longitudinal data (e.g., data that tracks the same type of information on the same subject(s) at multiple points in time). In some instances, each intervention from a plurality of interventions can be associated with its own sensitivity (e.g., a Hill model can be parameterized for each intervention from the plurality of interventions).

Below are equations for an example structural model demonstrating the selected parameterization for the system:

$$\frac{d ( {X}_{CP} )}{dt} = - {k}_{out , CP} * {X}_{CP}$$

$$\frac{d ( {X}_{Psych} )}{dt} = - {k}_{out , Psych} * {X}_{Psych}$$

$$\frac{d ( {X}_{Th} )}{dt} = - {k}_{out , Th} * {X}_{Th}$$

$$TRT = {\sum }_{{∀}_{i} ∈ \{ CP , Th , Psych \}} ( \frac{{X}_{i}}{{V}_{i}} )$$

$$\frac{d ( Dep )}{dt} = {T}_{i n , Dep} - {r}_{out , Dep} * ( 1 + \frac{{S}_{max} * TRT}{{SC}_{50} + TRT} )$$

$$∀ {k}_{out , i} \sim MV L ( {μ}_{{k}_{out , i}} , {θ}_{( 1 , {k}_{out , i} )} , {θ}_{( 2 , {k}_{out , i} )} , {σ}_{{k}_{out , i}}^{2} )$$

$$∀ {V}_{i} \sim MV L ( {μ}_{{V}_{i}} , {θ}_{( 1 , {V}_{i} )} , {θ}_{( 2 , {V}_{i} )} , {σ}_{{V}_{i}}^{2} )$$

$$∀ par \sim L N ( {μ}_{par} , {σ}_{par}^{2} )$$

$$[ {\sum }_{COV , {k}_{out}} ] = [ \begin{matrix}{σ}_{{k}_{out , CP}}^{2} & . & . \\ {σ}_{{k}_{out , CP} , {k}_{out , Th}} & {σ}_{{k}_{out , Th}}^{2} & . \\ {σ}_{{k}_{out , CP} , {k}_{out , Psych}} & {σ}_{{k}_{out , Th} , {k}_{out , Psych}} & {σ}_{{k}_{out , Psych}}^{2}\end{matrix} ]$$

$$[ {\sum }_{COV , V} ] = [ \begin{matrix}{σ}_{{V}_{CP}}^{2} & . & . \\ {σ}_{{V}_{CP} , {V}_{TH}} & {σ}_{{V}_{Th}}^{2} & . \\ {σ}_{{V}_{OP} , {V}_{psych}} & {σ}_{{V}_{th} , {V}_{Psych}} & {σ}_{{V}_{Psych}}^{2}\end{matrix} ]$$

$${\sum }_{COV} = [ \begin{matrix}[ {\sum }_{COV , {k}_{out}} ] & & & & & \\ & [ {\sum }_{COV , V} ] & & & & \\ & & {σ}_{{r}_{i n , Dep}}^{2} & & & \\ & & . & {σ}_{{r}_{out , Dep}}^{2} & & \\ & & . & . & {σ}_{{S}_{max}}^{2} & \\ & & . & . & . & {σ}_{{SC}_{50}}^{2}\end{matrix} ]$$

In this example, intervention “dosing” kinetics may be modeled as a first-order process. The TRT value is a sum of the scaled inputs at a given time for an individual i. The k_{out,i} and Vᵢ parameters are modeled as multivariate logit (MVL) in the population—including two shape parameters θ₁ and θ₂—while the other parameters (e.g., represented above as ∀ₚₐᵣ) for the depressive symptoms are modeled as lognormal (LN) distributions in the population. The covariance structure (ΣCOV) can implement the estimation of “kinetic” parameters (k_{out,i} and Vᵢ) for unobserved services based on population data from observed services (e.g., combinations of services); therefore, in this instance as shown above, two block matrices can be parameterized (e.g., generated) for the k_{out,i} and Vᵢ parameters (ΣCOV, kₒᵤₜ and ΣCOV, V respectively), while the portion of the covariance matrix representing the depressive symptom dynamics can be kept diagonal (i.e., is arranged diagonally) and assumed to be multivariate normal. In other examples, a covariance matrix may model more covariance terms or parameters (e.g., a covariance matrix that models more covariance terms). Based on these representations of relationships between parameters from a plurality of combinations of intervention types and timing, the model may calculate and/or predict (i.e., project) a number, and type(s), of future programs (e.g., interventions) to improve outcomes (e.g., symptom abatement) for a user.

In some instances, the structure of the covariance matrix can be user defined and/or tailored to estimate desired information. In some instances, by including at least one covariance term in a model, at least one parameter independency can be reduced or removed from the parameter estimation performed using the model. For example, including covariance terms in the covariance matrix (e.g., terms other than those at the matrix diagonal) can create a conditional expectation for an associated parameter(s) and can cause the model to constrain estimates on a parameter based on at least one other parameter. Different observed combinations of sessions/interventions across individuals in the population can be used to identify the most likely relationship between the parameters. Said differently, including a covariance matrix in a model can, in some instances, prevent the model from generating a parameter estimate associated with unobserved data at the individual level that is equivalent to a likelihood estimate at the population level (e.g., a “typical” value).

While the model described herein re-parameterizes the covariance structure as an MVL distribution, with potential to accommodate bimodality, in other examples, for example where parameters at a population-level exhibit multimodal distributions, an extensive covariate model or a mixture model approach may be adapted. In other examples, reinforcement learning may be implemented with the framework, for example, combined with a non-linear mixed effects model. In still other examples, different computational frameworks may be used to model the data, such as, for example: recurrent neural networks (RNN), long short-term memory (LSTM) networks, Bayesian networks, Bayesian structural time series, graph neural networks, and/or the like. In some instances, reinforcement learning can be used to receive, intake and/or consume an output of symptom and/or session/intervention data to improve predictions and/or recommendations. In some implementations, a computational framework (e.g., a computational framework beyond hierarchical systems dynamics models) can be used to model a longitudinal relationship between inputs and outputs.

While the framework model 400 and the equations herein depict a structural model for depression (i.e., depressive symptoms), the same structural model may be used for other {symptom, severity} pairs for various mental health conditions and disorders. In some examples, other parameterizations or structural models may be used for other types of symptoms (e.g., other mental health conditions or disorders not described herein). In some examples, the model may be adapted to account for dependencies between symptoms (e.g., improvements or decompensations on one symptom may be a consequence of movement on another symptom).

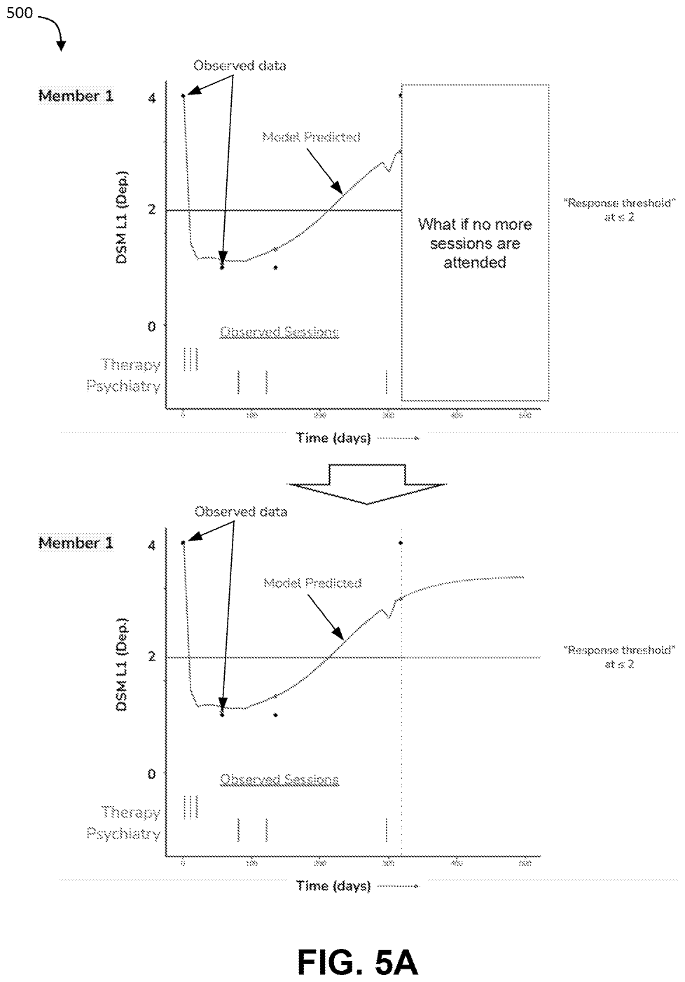

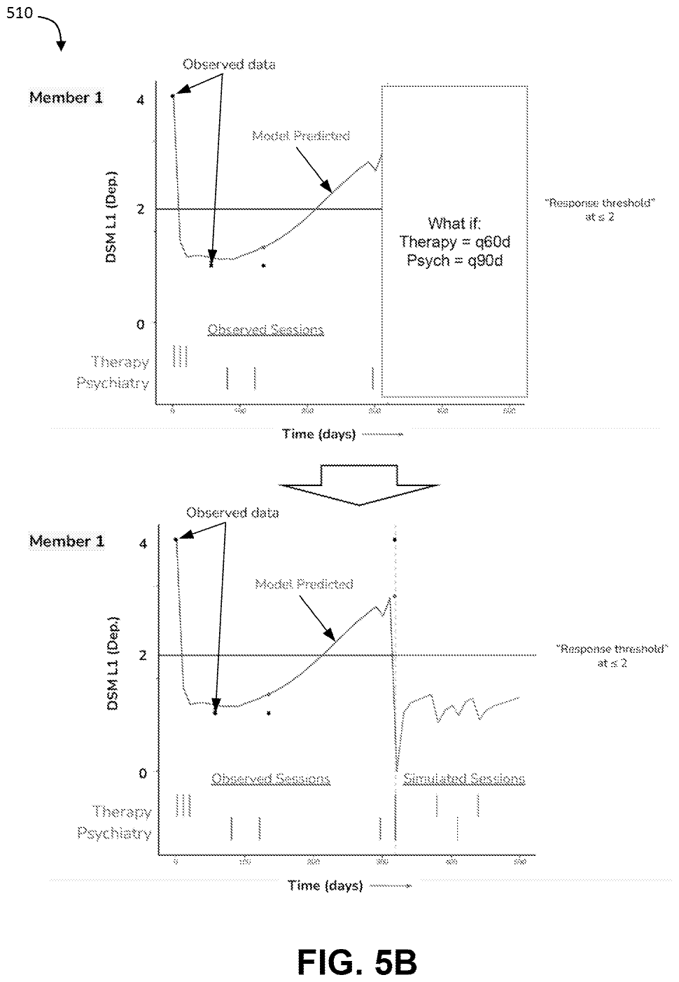

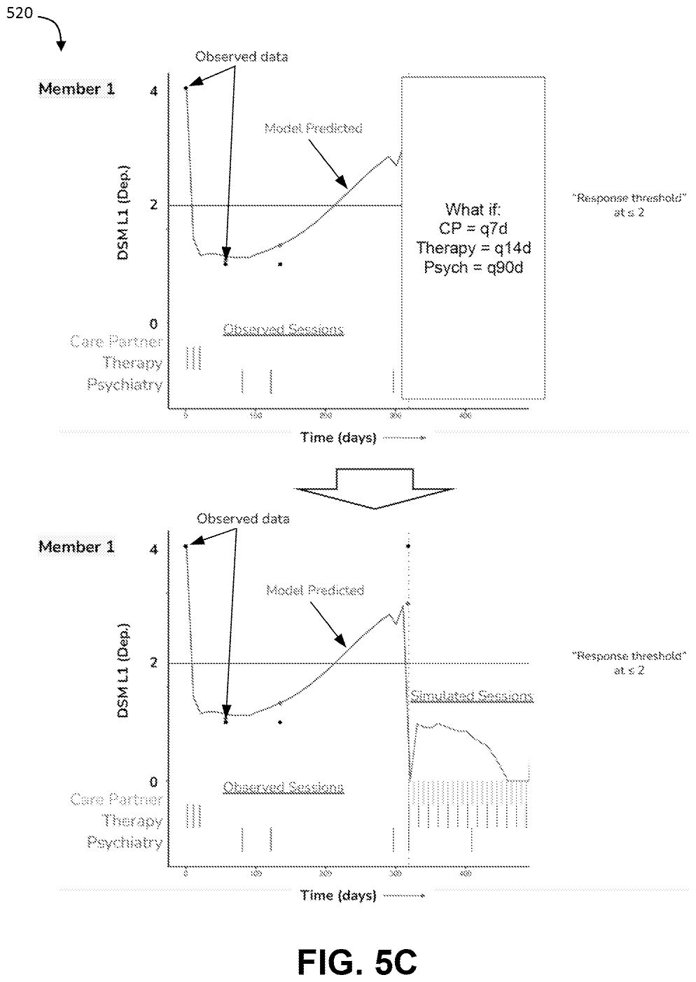

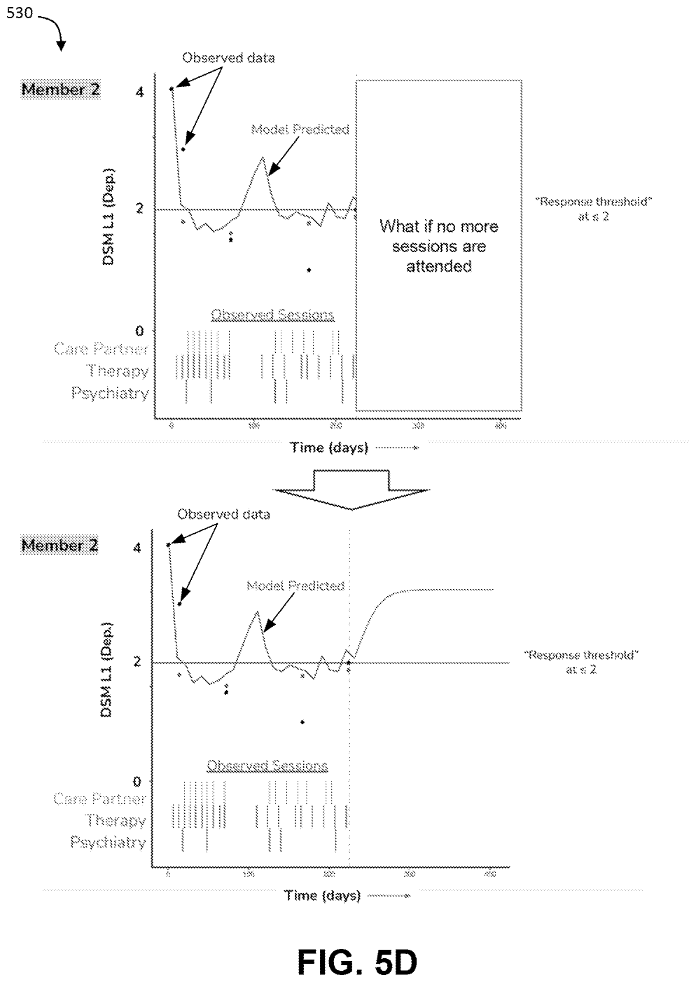

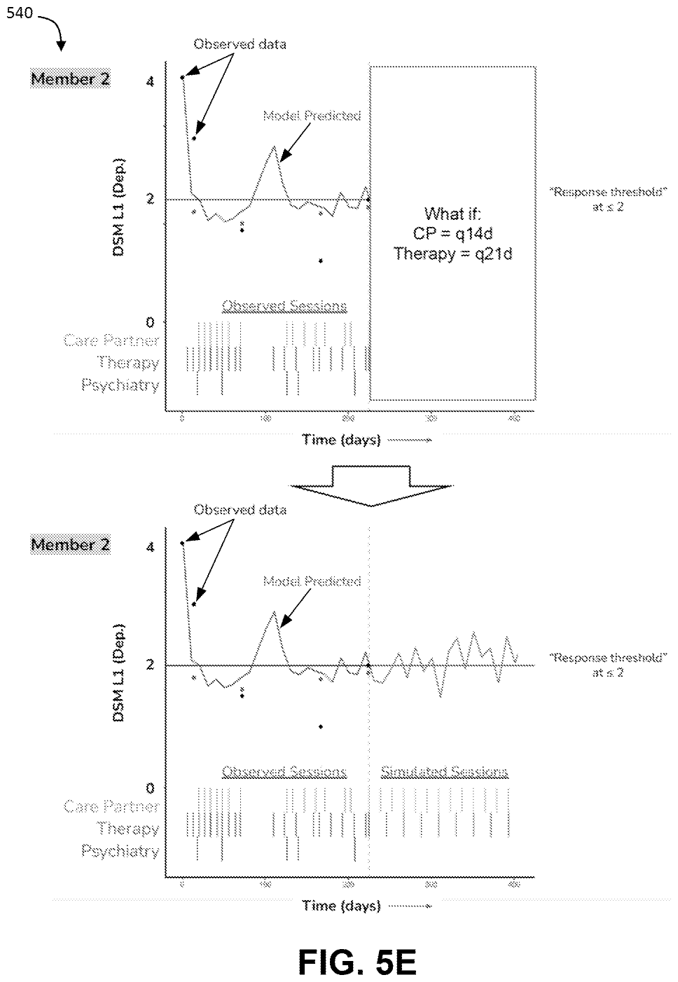

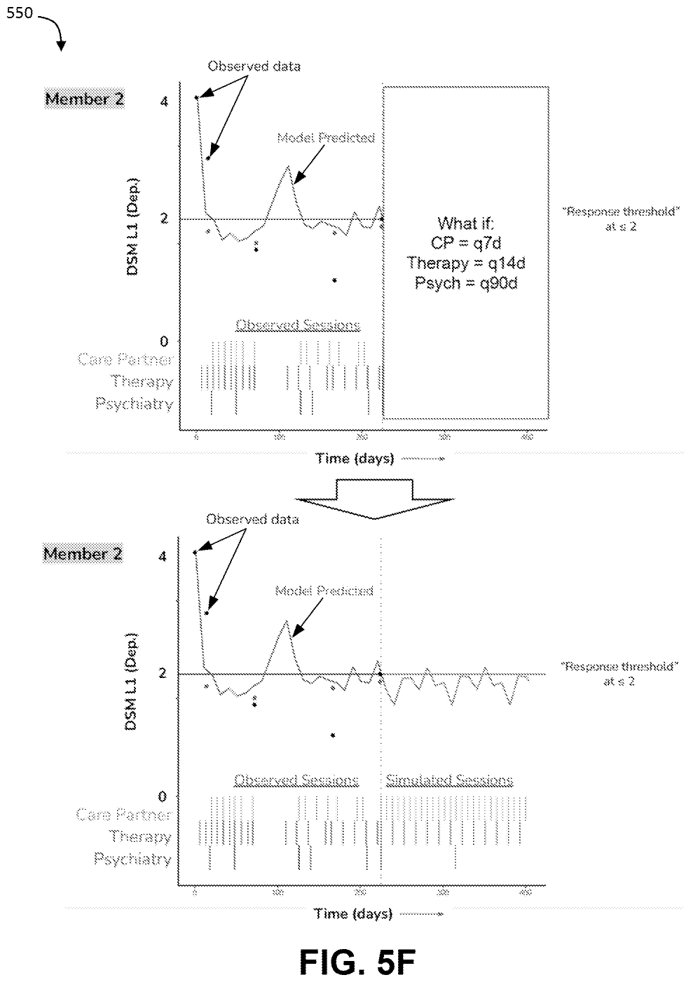

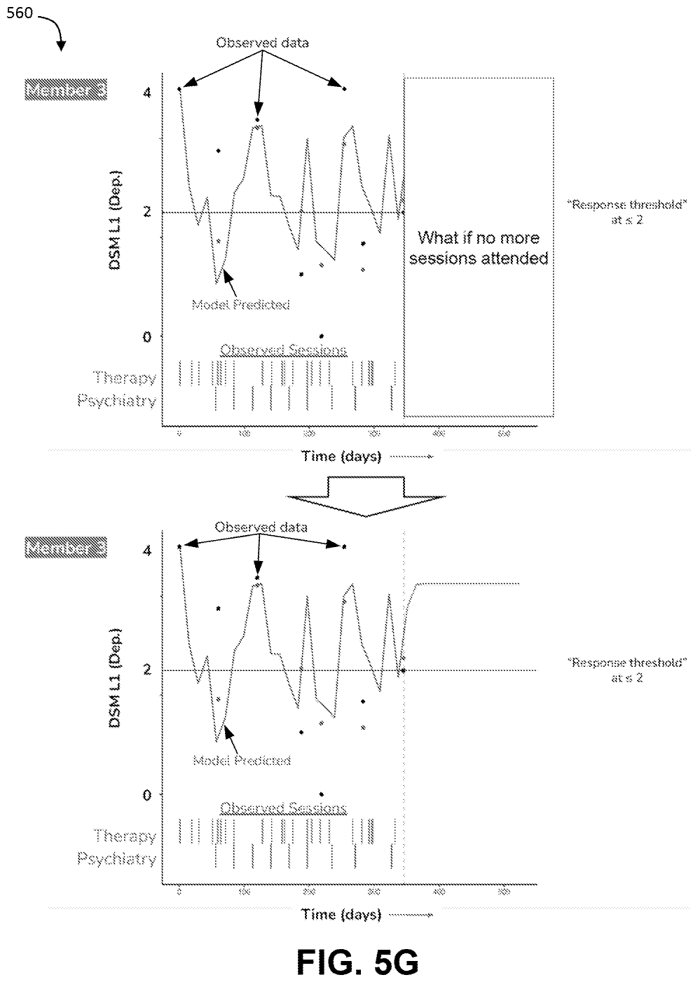

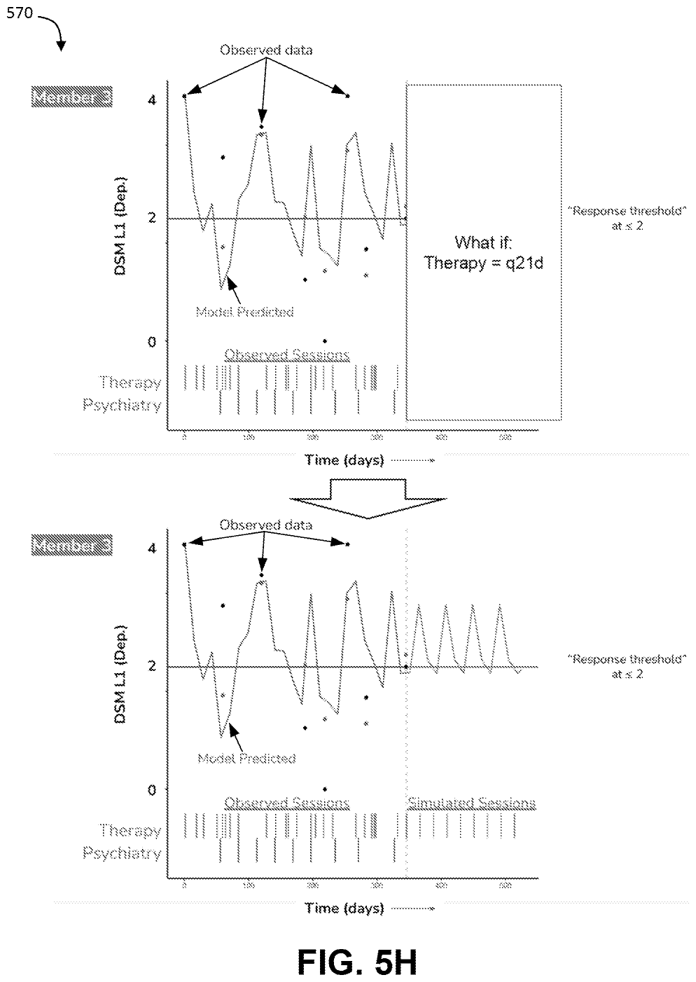

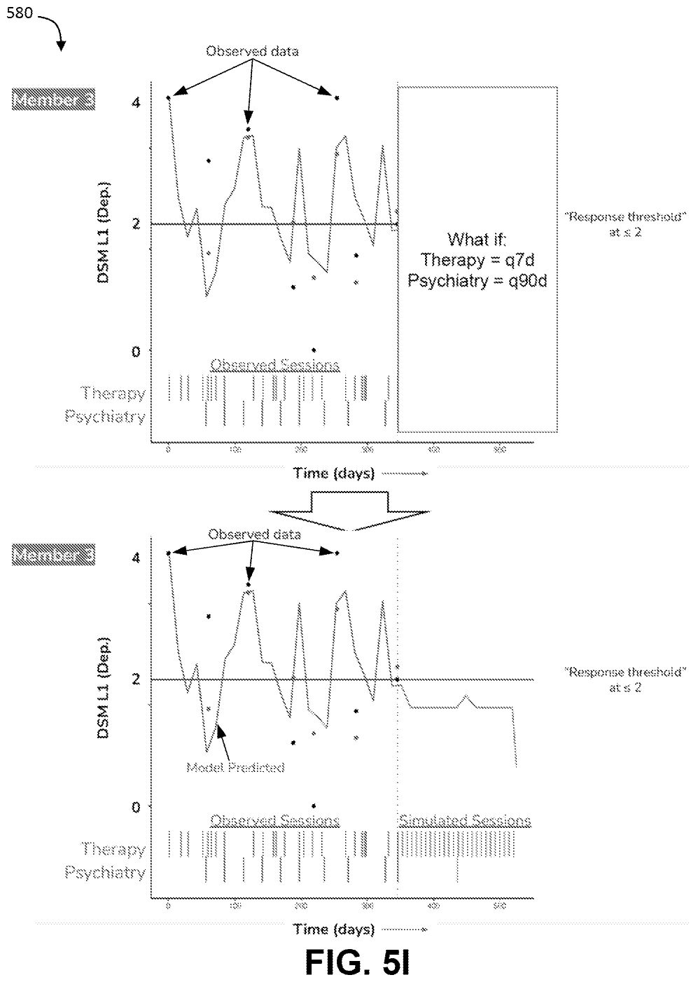

FIGS. 5A-5I are charts showing example modeled predictions of treatment outcomes for example users, in accordance with one or more embodiments. More specifically, FIGS. 5A-5I show two tasks: (1) modeling original data to generate individual parameter values for the data, and (2) simulating out expected trajectories of the observation value given a new set of inputs. In some examples, one or more of the modeled predictions may be used to provide a recommendation configured to improve an outcome for each user. In some examples, a low touch (e.g., no further services), medium touch (e.g., estimated moderate schedule of services), and high touch (e.g., more intense schedule of services) may be modeled to determine which level would result in an improvement (e.g., more effective given symptom reduction or other mental health goals). In some examples, additional schedules and combinations of services may be predicted. Example data including observed symptoms (i.e., quantitative symptoms data) can be overlaid on top of intervention schedules (i.e., intervention data). Intervention data may include a type of intervention, as well as a number, duration, and timing (e.g., frequency, schedule) of each type of intervention. The lines in each chart represent the model fit for the period of observed data and a simulated (i.e., predicted) symptom response trajectory for a given therapeutic approach (e.g., number and frequency of one or more types of interventions) for a given time frame (e.g., 6 months is shown, but may be shorter or longer time frame). The q* nomenclature (e.g., q60d, q14d, q90d) represents a frequency of an intervention type in the simulated data (e.g., every 60 days, every 14 days, every 90 days). From these modeled predictions, an improved recommendation of future intervention types, along with a number and schedule of said future intervention types, may be determined.

In FIG. 5A, as shown in charts 500, the model predicts that if no more interventions are attended, the symptom response trajectory will continue to increase (e.g., increase toward a higher severity). For the same user, in FIG. 5B, charts 510 show the model predicting a steep decline in the symptom response trajectory after an immediate or almost immediate “dose” (i.e., intervention), including a therapy intervention and a psychiatric intervention, and maintenance of a relatively low symptom response trajectory thereafter with a therapy intervention every 60 days and psychiatric intervention every 90 days. For the same user, in FIG. 5C, charts 520 show a predicted symptom response trajectory for a simulation of a care partner intervention every 7 days, a therapy intervention every 14 days, and a psychiatric intervention every 90 days. In FIG. 5D, for a second user, charts 530 show a symptom response trajectory for a simulation of no more interventions. FIG. 5E, charts 540 show a symptom response trajectory for the second user for a simulation of a care partner intervention every 14 days and a therapy intervention every 21 days. In FIG. 5F, charts 550 show a symptom response trajectory for the second user for a simulation of a care partner intervention every 7 days, a therapy intervention every 14 days, and a psychiatric intervention every 90 days. In FIG. 5G, for a third user, charts 560 show a symptom response trajectory for a simulation of no more interventions. In FIG. 5H, charts 570 show a symptom response trajectory for the third user for a simulation of a therapy intervention every 21 days. In FIG. 5I, charts 580 show a symptom response trajectory for the third user for a simulation of a therapy intervention every 7 days and a psychiatric intervention every 90 days.

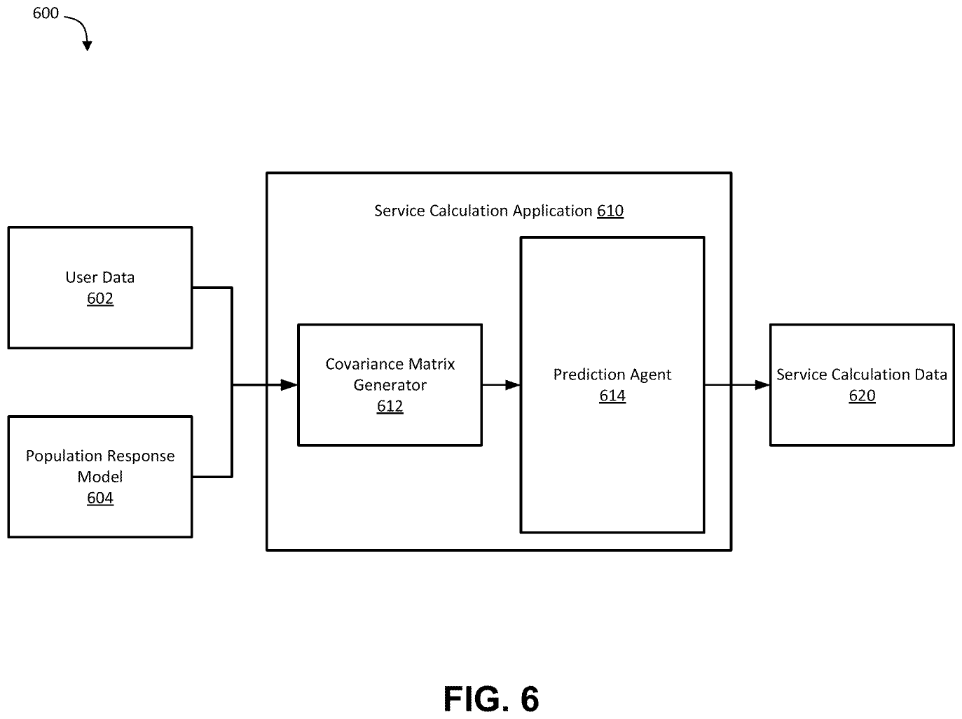

FIG. 6 is a schematic diagram of service calculation components 600, according to one embodiment. The service calculation components 600 can be associated with a compute device (e.g., a compute device that is structurally and/or functionally similar to the compute device 201 of FIG. 2 and/or the compute devices 110-120 of FIG. 1). In some instances, for example, the service calculation components 600 can be software stored in memory 210 and configured to execute via the processor 220 of FIG. 2. In some instances, for example, at least a portion of the service calculation components 600 can be implemented in hardware. The service calculation components 600 include user data 602, a population response model 604, the service calculation application 610, and the service calculation data 620. The service calculation application 610 can be functionally and/or structurally similar to the service calculation application 112 of FIG. 1.

The user data 602 can include past state data/observations associated with a specific user. For example, the user data 602 can include symptom data, as described herein. In some instances, the user data 602 can include one or more intensity values associated with a state (e.g., a symptom). For example, the one or more intensity values can be associated with quantitative symptom data, as described herein.

The population response model 604 can include a model configured to estimate one or more population-level responses (e.g., an average, weighted average, other distributional characteristics, and/or aggregate measure of values from a plurality of users' symptom report data). A population can include, for example, mental health patients, members of a mental healthcare platform or community, and/or some other person seeking mental healthcare services. In some examples, the population response model 604 can be associated with the general population of users or may be broken down to represent a subset of the population of users. For example, the population response model 604 can be configured to represent one or more demographics (e.g., age, gender, geography, education, ethnicity). In another example, the population response model 604 can be configured to represent one or more mental conditions or disorders (e.g., disorders identified in the Diagnostic and Statistical Manual of Mental Disorders (DSM), such as depression, anxiety, addiction, impulse control, affective disorders, psychotic disorders, eating disorders, as well as other mental health disorders). In some implementations, the population response model 604 can include a nonlinear mixed effects model, as described herein. In some implementations, the population response model 604 can include at least one of a recurrent neural networks (RNN), a long short-term memory (LSTM) network(s), a Bayesian network(s), a Bayesian structural time series, a graph neural network(s), and/or the like.

In some instances, the population response model 604 can include a state model, an activity dissipation model, and an activity magnitude model. The state model can be associated with, for example, population user state (e.g., symptom) data, and can be configured to generate symptom dynamics data, as described herein. The activity dissipation model can be configured to, for example, represent a diminished effect (e.g., over a period time) that an activity (e.g., attending an intervention) has on a state (e.g., a symptom, such as a depressive symptom and/or the like). The diminishing effect can be associated with an activity impact dissipation parameter (e.g., dissipation rate over time (k_{out,i}), as described herein). The activity magnitude model can be configured to represent the magnitude and duration (e.g., sensitivity) of the impact of an activity (e.g., an intervention type). In some instances, such as when a population does not include a specific user, the activity impact dissipation parameter and/or the activity magnitude parameter can be unobserved (as to the specific user). The activity magnitude model can also generate an activity scaling parameter (e.g., Vᵢ and/or an activity magnitude parameter, as described herein). In some instances, the activity dissipation model can include a first multivariate logit (MVL) model, and the activity magnitude model can include a second multivariate logit (MVL) model.

The covariance matrix generator 612 can be configured to generate one or more covariance matrices based on the user data 602 and/or the population response model 604. In some instances, the generating can include parameterizing (e.g., populating) a covariance matrix whose structure is pre-defined (e.g., by a user). In some instances, the generating can include generating (1) a covariance matrix structure and (2) data to be included in the generated structure. The one or more covariance matrices can include, for example, the covariance structure ΣCOV described in relation to FIG. 4. This covariance structure can include additional covariance matrices/structures (e.g., ΣCOV, kₒᵤₜ and ΣCOV, V), as described herein.

The prediction agent 614 can use the covariance structure(s) generated by the covariance matrix generator 612 to predict (i.e., project) the effects of an unobserved activity and/or a combination of unobserved activities on a specific user's state (e.g., symptom). Said differently, the prediction agent 614 can calculate (e.g., predict) a specific user's future state (e.g., symptom) based on a hypothetical activity impact dissipation parameter and/or a hypothetical activity magnitude parameter, where said parameters are associated with one or more activity (e.g., intervention) types. For example, based on these representations of relationships between parameters from a plurality of combinations of intervention types and timing, the prediction agent can estimate symptom dynamic parameter(s) and generate a predicted (i.e., future) activity magnitude parameter(s), and/or activity impact dissipation parameter, specific to a user and based on new user inputs. Based on these predictions, the service calculation application 112 can be configured to generate service calculation data 620 based on, for example, an improvement and/or an optimization (e.g., increase and/or maximization) of a symptom reduction value. The symptom reduction value can be determined based on the a user's previous state (e.g., symptom intensity value), an activity's dosing strength, and an activity's dissipative effect over time. The service calculation data 620 can include, for example, a schedule of activities/services.

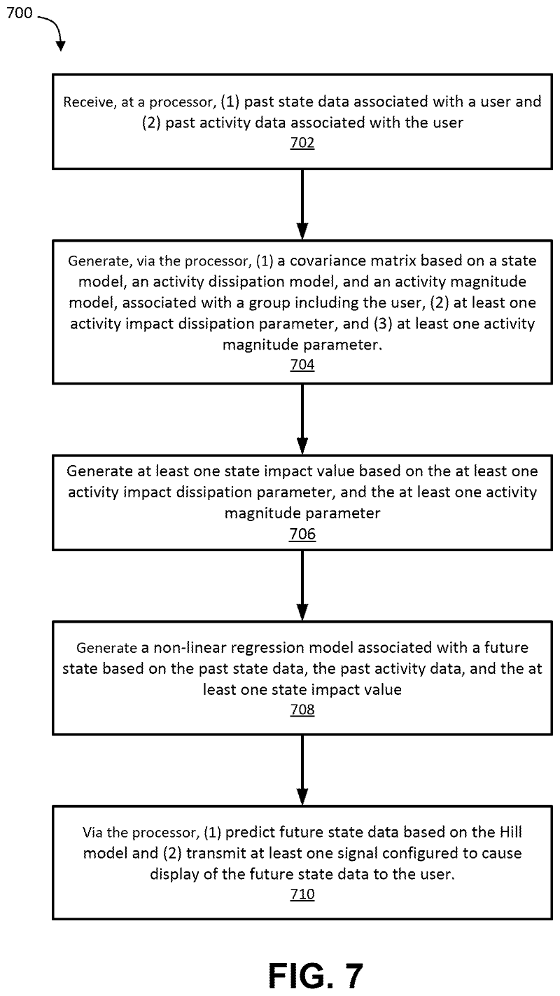

FIG. 7 is a flowchart showing a method 700 illustrating an example implementation using a service recommendation system, according to an embodiment. The method 700 can be implemented by a data storage system described herein (e.g., the system 100 of FIG. 1). Portions of the method 700 can be implemented using a processor(s) (e.g., the processor 220 of FIG. 2) of a suitable compute device(s) (e.g., the compute device 201 of FIG. 2, and/or the compute devices 110 and/or 120 of FIG. 1).

At 702, the method 700 includes receiving, at a processor, past state data associated with a user and past activity data associated with the user. At 704, the method 700 includes generating, via the processor, (1) a covariance matrix based on a state model, an activity dissipation model, and an activity magnitude model, associated with a group including the user, (2) at least one activity impact dissipation parameter associated with the user, and (3) at least one activity magnitude parameter associated with the user. At 706, the method 700 includes generating at least one state impact value based on the at least one activity impact dissipation parameter, and the at least one activity magnitude parameter. At 708, the method 700 includes generating a non-linear regression model associated with a future state based on the past state data, the past activity data, and the at least one state impact value. At 710, the method 700 includes calculating, via the processor, future state data based on the non-linear regression model. The method 700 at 710 also includes transmitting, via the processor, at least one signal configured to cause display of the future state data to the user.

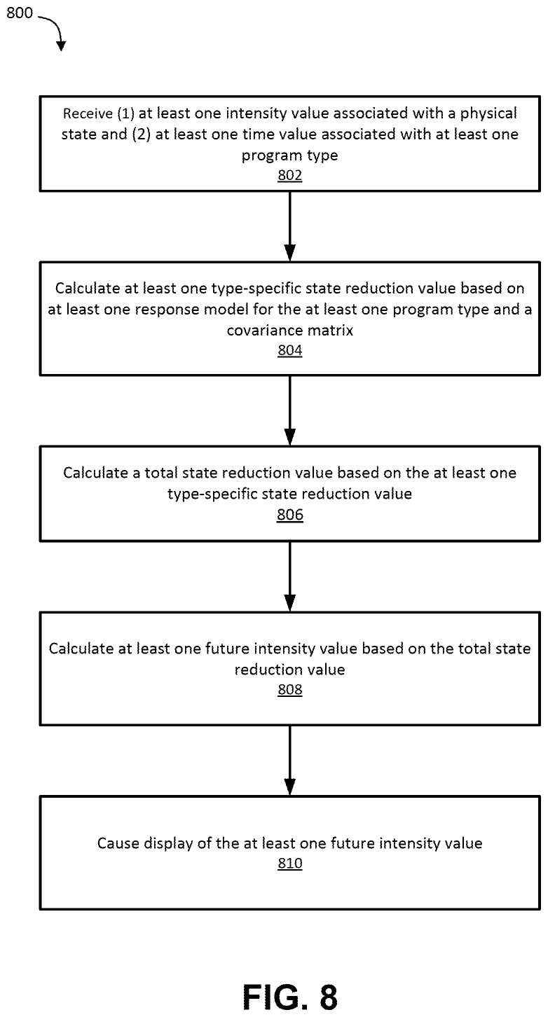

FIG. 8 is a flowchart showing a method 800 illustrating an example implementation using a service system, according to an embodiment. The method 800 can be implemented by a data storage system described herein (e.g., the system 100 of FIG. 1). Portions of the method 800 can be implemented using a processor(s) (e.g., the processor 220 of FIG. 2) of a suitable compute device(s) (e.g., the compute device 201 of FIG. 2, and/or the compute devices 110 and/or 120 of FIG. 1).

At 802, the method 800 includes receiving (1) at least one intensity value associated with a physical state and (2) at least one time value associated with at least one program type. At 804, the method 800 includes calculating at least one type-specific state reduction value based on at least one response model for the at least one program type and a covariance matrix. At 806, the method 800 includes calculating a total state reduction value based on the at least one type-specific state reduction value. At 808, the method 800 includes calculating at least one future intensity value based on the total state reduction value. At 810, the method 800 includes causing display of the at least one future intensity value.

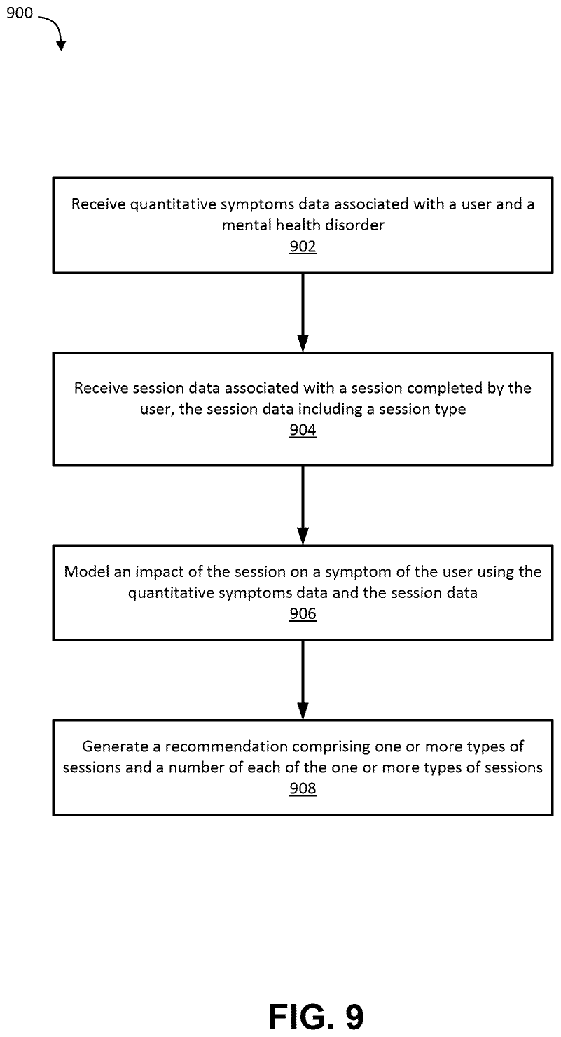

FIG. 9 is a flow diagram illustrating an example method 700 for generating mental healthcare services recommendations to improve outcomes, in accordance with one or more embodiments. The method 900 can be implemented by a data storage system described herein (e.g., the system 100 of FIG. 1). Portions of the method 900 can be implemented using a processor(s) (e.g., the processor 220 of FIG. 2) of a suitable compute device(s) (e.g., the compute device 201 of FIG. 2, and/or the compute devices 110 and/or 120 of FIG. 1).

The method 900 begins with receiving quantitative symptoms data associated with a user and a mental health disorder, at step 902. In some examples, the quantitative symptoms data may be based at least in part on self-reported symptoms. In some examples, the quantitative symptoms data may include self-reported symptom dynamics data, or other symptom dynamics data, as described herein (e.g., based on responses to a symptom survey or other data sources). Intervention data also may be received at step 904, the intervention data being associated with an intervention completed by the user. In some examples, the intervention data includes an intervention type. As described herein, intervention data may include a type of the intervention, a date and/or time of the intervention, a frequency or schedule of the type of interventions, a duration of the type of intervention, and other data associated with one or more interventions. An impact of the intervention on a symptom of the user may be modeled using the quantitative symptoms data and the intervention data at step 906, for example, using the framework described herein. A recommendation including one or more types of interventions and a number of each of the one or more types of interventions may be generated at step 908. For example, a recommendation can be generated (e.g., using reinforcement learning) based on a set of additional inputs (e.g., a goal). In some instances, the method can generate an expectation of an evolution of a symptom(s) instead of a formal recommendation. For example, as shown in FIG. 5, the response goal is represented by a horizontal dashed line, which is a representation of how the symptoms would be expected to evolve given new inputs. As described herein, the one or more types of interventions may include a care partner intervention, a therapy intervention, a psychiatric intervention, and other mental health service.

While specific examples have been provided above, it is understood that embodiments can be applied with a wide variety of inputs, thresholds, ranges, models, and other factors, depending on the application. For example, the time frames and other ranges provided above are illustrative, and in some implementations, these time frames and ranges may be varied or even be dynamic and variable.

In an embodiment, a method includes receiving, at a processor, past state data associated with a user and past activity data associated with the user. The method also includes generating, via the processor, (1) a covariance matrix based on a state model, an activity dissipation model, and an activity magnitude model, associated with a group including the user, (2) at least one activity impact dissipation parameter associated with the user, and (3) at least one activity magnitude parameter associated with the user. The method also includes generating at least one state impact value based on the at least one activity impact dissipation parameter, and the at least one activity magnitude parameter. The method also includes generating a non-linear regression model (e.g., a Hill model, a first-order kinetics model, and/or the like) associated with a future state based on the past state data, the past activity data, and the at least one state impact value. The method also includes calculating, via the processor, future state data based on the non-linear regression model. The method also includes transmitting, via the processor, at least one signal configured to cause display of the future state data to the user.

In some implementations, the state model can be associated with a lognormal distribution. In some implementations, the activity dissipation model can be a multivariate logit model. In some implementations, the activity magnitude model can be a multivariate logit model. In some implementations, at least one of the state model, the activity dissipation model, or the activity magnitude model can be associated with at least one of an extensive covariate model, a mixture model, a non-linear mixed effects model, a neural network, or a Bayesian model.

In some implementations, the generating the covariance matrix can include generating, via the processor, an observed activity impact dissipation parameter and an observed activity magnitude parameter based on the past state data and the past activity data, the observed activity impact dissipation parameter and the observed activity magnitude parameter associated with the user. The generating the covariance matrix can also include generating the covariance matrix based on the observed activity impact dissipation parameter and the observed activity magnitude parameter.

In some implementations, the future state data can include at least one of a predicted state or a potential future treatment process. In some implementations, the past state data can include an indication of a physical state, and the past activity data can include at least one of an indication of a program time, an indication of program frequency, or an indication of a program duration. In some implementations, the at least one state impact value is associated with a reduction in a quantitative value associated with the past state data. In some implementations, the covariance matrix can be associated with the at least one of a bimodal distribution or a multi-modal distribution.

In an embodiment, a non-transitory processor-readable medium stores code representing instructions to be executed by one or more processors, the instructions including code to cause the one or more processors to receive (1) at least one intensity value associated with a physical state and (2) at least one time value associated with at least one program type. The code also causes the one or more processors to calculate at least one type-specific state reduction value associated with the physical state based on at least one response model for the at least one program type and the at least one time value. The code also causes the one or more processors to calculate a total state reduction value based on the at least one type-specific state reduction value. The code also causes the one or more processors to calculate at least one future intensity value based on the total state reduction value. The code also causes the one or more processors to cause display of the at least one future intensity value.

In some implementations, the at least one response model can include longitudinal data. In some implementations, the at least one response model can include a lognormal distribution for state dynamics, a first multivariate logit model for dissipation of program effect, and a second multivariate logit model for program magnitude. In some implementations, the code to cause the one or more processors to calculate the at least one type-specific state reduction value can include code to cause the one or more processors to generate (1) a first covariance matrix portion associated with the first multivariate logit model, (2) a second covariance matrix portion associated with the second multivariate logit model, and (3) a third covariance matrix portion associated with the lognormal distribution, where the first covariance matrix portion, the second covariance matrix portion, and the third covariance matrix portion are diagonally arranged. The code can also cause the one or more processors to parameterize the at least one response model based on the first covariance matrix portion, the second covariance matrix portion, and the third covariance matrix portion.

In some implementations, the instructions can further include code to cause the one or more processors to improve a program based on the at least one future intensity value, at least one constraint, and reinforcement learning. In some implementations, the at least one response model can include at least one of a mixture model, a non-linear mixed effects model, a recurrent neural network, a long short-term memory (LSTM) network, a Bayesian network, a Bayesian structural time series, or a graph neural network. In some implementations, the code can further include code to cause the one or more processors to generate a process based on the at least one future intensity value, the process configured to improve the physical state. In some implementations, the code can further include code to cause the one or more processors to generate the process based on at least one of a user availability and a cost. In some implementations, the at least one intensity value, the at least one time value, and the at least one future intensity value can each be arranged sequentially. In some implementations, the at least one time value can include an indication of at least one of a program date, a program duration, a program frequency, or a program interval.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™ and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. A method comprising:
receiving, at a processor, (1) past state data associated with a user and (2) past activity data associated with the user;
generating, via the processor, (1) a covariance matrix based on a state model, an activity dissipation model, and an activity magnitude model, associated with a group including the user, (2) at least one activity impact dissipation parameter associated with the user, and (3) at least one activity magnitude parameter associated with the user;
generating at least one state impact value based on the at least one activity impact dissipation parameter, and the at least one activity magnitude parameter;
generating a non-linear regression model associated with a future state based on the past state data, the past activity data, and the at least one state impact value;
calculating, via the processor, future state data based on the non-linear regression model; and
transmitting, via the processor, at least one signal configured to cause display of the future state data to the user.

2. The method of claim 1, wherein the state model is associated with a lognormal distribution.

3. The method of claim 1, wherein the activity dissipation model is a multivariate logit model.

4. The method of claim 1, wherein the activity magnitude model is a multivariate logit model.

5. The method of claim 1, wherein at least one of the state model, the activity dissipation model, or the activity magnitude model is associated with at least one of an extensive covariate model, a mixture model, a non-linear mixed effects model, a neural network, or a Bayesian model.

6. The method of claim 1, wherein the generating the covariance matrix includes:
generating, via the processor, an observed activity impact dissipation parameter and an observed activity magnitude parameter based on the past state data and the past activity data, the observed activity impact dissipation parameter and the observed activity magnitude parameter associated with the user; and
generating the covariance matrix based on the observed activity impact dissipation parameter and the observed activity magnitude parameter.

7. The method of claim 1, wherein the future state data includes at least one of a predicted state or a potential future treatment process.

8. The method of claim 1, wherein:
the past state data includes an indication of a physical state; and
the past activity data includes at least one of an indication of a program time, an indication of program frequency, or an indication of a program duration.

9. The method of claim 1, wherein the at least one state impact value is associated with a reduction in a quantitative value associated with the past state data.

10. The method of claim 1, wherein the covariance matrix is associated with the at least one of a bimodal distribution or a multi-modal distribution.

11. A non-transitory processor-readable medium storing code representing instructions to be executed by one or more processors, the instructions comprising code to cause the one or more processors to:
receive (1) at least one intensity value associated with a physical state and (2) at least one time value associated with at least one program type;
calculate at least one type-specific state reduction value associated with the physical state based on (a) at least one response model for the at least one program type and (b) the at least one time value;
calculate a total state reduction value based on the at least one type-specific state reduction value;
calculate at least one future intensity value based on the total state reduction value; and
cause display of the at least one future intensity value.

12. The non-transitory processor-readable medium of claim 11, wherein the at least one response model includes longitudinal data.

13. The non-transitory processor-readable medium of claim 11, wherein the at least one response model includes a lognormal distribution for state dynamics, a first multivariate logit model for dissipation of program effect, and a second multivariate logit model for program magnitude.

14. The non-transitory processor-readable medium of claim 13, wherein the code to cause the one or more processors to calculate the at least one type-specific state reduction value includes code to cause the one or more processors to:
generate a first covariance matrix portion associated with the first multivariate logit model, a second covariance matrix portion associated with the second multivariate logit model, and a third covariance matrix portion associated with the lognormal distribution, the first covariance matrix portion, the second covariance matrix portion, and the third covariance matrix portion being diagonally arranged; and
parameterize the at least one response model based on the first covariance matrix portion, the second covariance matrix portion, and the third covariance matrix portion.

15. The non-transitory processor-readable medium of claim 11, wherein the instructions further include code to cause the one or more processors to improve a program based on the at least one future intensity value, at least one constraint, and reinforcement learning.

16. The non-transitory processor-readable medium of claim 11, wherein the at least one response model includes at least one of a mixture model, a non-linear mixed effects model, a recurrent neural network, a long short-term memory (LSTM) network, a Bayesian network, a Bayesian structural time series, or a graph neural network.

17. The non-transitory processor-readable medium of claim 11, wherein the code further comprises code to cause the one or more processors to generate a process based on the at least one future intensity value, the process configured to improve the physical state.

18. The non-transitory processor-readable medium of claim 17, wherein the code further comprises code to cause the one or more processors to generate the process based on at least one of a user availability and a cost.

19. The non-transitory processor-readable medium of claim 11, wherein the at least one intensity value, the at least one time value, and the at least one future intensity value are each arranged sequentially.

20. The non-transitory processor-readable medium of claim 11, wherein the at least one time value includes an indication of at least one of a program date, a program duration, a program frequency, or a program interval.
